(19) United States
(12) Patent Application Publication
(10) Pub. No.: US 2014/0337042 A1
(43) Pub. Date: Nov. 13, 2014

(54) Bus Stop Systems And Methods Of Scheduling

(71) Applicant: NMETRIC, LLC, Costa Mesa, CA (US)

(72) Inventors: Mac Joiner, Costa Mesa, CA (US); William N. Turley, Costa Mesa, CA (US); Christine L. Koski, Dallas, TX (US)

(73) Assignee: nMetric, LLC, Costa Mesa, CA (US)

(21) Appl. No.: 13/889,786

(22) Filed: May 8, 2013

(51) Int. Cl. G06Q 10/06

(52) U.S. Cl. CPC G06Q 10/06316
USPC 705/2; 705/7.26

(57) ABSTRACT

Demand data is used to modify a previously established cycle for use of a resource, at least in part by bypassing (skipping over) one, two, or perhaps three or more of the steps in the cycle. When done appropriately, the inventive subject matter can improve at least one measure of efficiency. The inventive subject matter has particular applicability to Kanban type schedules. The inventive subject matter also has particular applicability to manufacturing, although it can be used with respect to physical or non-physical products, including services.

### FIELD OF THE INVENTION

The field of the invention is automated scheduling of equipment and other resources,

### BACKGROUND

There are many types of things that can be advantageously scheduled, This includes usage of manufacturing or other types of equipment, various tools, consumables, people, animals, buildings, rooms or other locations, and even intangibles such as procedures and access to data, software, sensors, etc. Indeed, as used herein, the term “resources” should be interpreted broadly to include anything that the use of which can be scheduled.

The importance of scheduling in a manufacturing environment can be obviated to some extent by increasing inventory, either finished goods inventory or work in process inventory. But the tradeoff is not always satisfactory. Inventory is expensive to produce and store, and suffers from possible degradation and obsolescence, In addition to the stock replenishment model, scheduling is important in make-to-order manufacturing environments, where shop orders are associated with a client order, and poor scheduling can result in extremely inefficient operation.

In service fields, trying to minimize the importance of scheduling by increasing inventory is either not even possible because the “product” being provided either cannot be stored, or is impractical because the “product” is unique to a particular circumstance. For example, medical examinations cannot be inventoried for future use, and must be done on specific patients, when the patients are available and the need arises. Analogous situations exist for plumbers, electricians and other service professionals, who only have so much time each day, and must maximize service time and minimize transit time.

Years ago Toyota Production System (TPS) pioneered the concept of “lean manufacturing”, which was designed to reduce inventory costs of manufactured goods by producing the goods according to efficient production cycles. Among other things, TPS-type strategies design production cycles that minimize setup costs for making different parts on a given machine. Thus, if a machine is used to produce parts 1-6, it may be that the sum of all the setup times to produce each of the parts is smallest in the following cycle, 1=>3=>4=>6=>2=>5=>1 . . . . Once a cycle is determined to be the most cost-effective or a given piece of equipment, TPS-type systems continue to use that equipment according to that cycle, regardless of short term fluctuations in demand.

Although TPS systems have gained the most acceptance in manufacture of tangible goods, analogous strategies can be used in other contexts. For example in scheduling a conference room that is used for the same four meetings each day, with meetings 1 and 3 requiring tables and chairs, and meeting 2 and 4 requiring only chairs, a TPS type system might schedule the meetings in the order of 1=>3=>2=>4 rather than 1=>2=>3=>4 to minimize the setup time with respect to the tables.

Further discussion of TPS type scheduling can be found in U.S. Pat. No. 7,908,127 to Weignang et al. (2011), and U.S. Pat. No. 6,889,178 to Chacon (2005), Patents addressing sophisticate scheduling systems that do not use TPS include U.S. Pat. No. 8,185,422 to Yurekli (2012), US20070021998 to Laithwaite (publ. 2007), and US20090315735 to Bhavani (publ. 2009). These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Interestingly, despite years of experience with TPS type scheduling, in many countries around the globe, there is still a need for systems and methods that can adapt such systems, in real time, to changes in short-term demand for parts scheduled to be produced according to a pre-established cycle.

### SUMMARY OF THE INVENTION

The inventive subject matter provides apparatus, systems and methods in which demand data is used to modify a previously established cycle for use of a resource, at least in part by bypassing (skipping over) one, two, or perhaps three or more of the steps in the cycle. When done appropriately, the inventive subject matter can improve at least one measure of efficiency.

Demand data can be acquired from any suitable sources, including especially electronic or printed orders. Of particular interest is demand data that reflects quantities and delivery or production dates, and flexibility in production which should be construed as performance in the case of a service).

A previously established cycle can be one in which a sequence for use of the resource is optimized by minimizing or at least reducing one or more costs. In this context all possible costs are contemplated, including especially any one or more of setup costs, runtime or other activity time costs, energy costs, disposal costs, loss of business costs, penalty costs, and reputation costs. it is also contemplated that individual steps can have substeps, so that, for example, a sequence could be optimized based on minimizing or reducing a cost related to one or more substeps, As used herein, the “minimizing” means reducing something to a lowest commercially practical level, which might or might not be zero, and which might or might not be the lowest possible level.

Improvement in one measure of efficiency can be found in reducing a cost by bypassing the aforementioned steps. Such costs can be specific to the resource or type of resource, By way of example, where the resource being scheduled is a machine, the setup costs can be associated with re-tooling the machine, which for example, can include physical re-tooling and/or running different software. For software, setup costs can be associated with gaining access to, or perhaps training in use of the software. For labor, setup costs can be associated with getting a person to a desired location, training, dealing with safety issues, and/or outfitting the person for service, with protective gear or other appropriate clothing, or in some other manner. For a consumable, setup costs can be associated with getting the consumable to a desired location, and/or outfitting preparing the consumable for use. Where the resource is a physical location, setup costs can be associated with prepping the location for use, which could, for example, include bringing a piece of equipment at the location and/or configuring a piece of equipment already at the location.

Improvement in another measure of efficiency can be found in increased production (increased capacity utilization) from one or more resources.

In many cases, resources are used to produce product(s). Products produced in accordance with the inventive subject matter can advantageously be grouped into families, and possibly subfamilies. In the case of physical products, families might include different sizes, components, wirings etc of a given part or assembly. An example is a family of screws, where the family includes different lengths, thread configurations and head shapes for a given diameter shaft. In the case of service products, families might include variations on a given medical or other procedure. Family designations are considered most useful where there are relatively smaller variations in costs of sequentially producing different members of the family relative to a family member and a non-family member. Subfamily members are considered to have even smaller such variations in costs.

Software implementing aspects of the inventive subject matter can be written to metaphorically relate to a bus or other transportation routing system, where different steps in production of a single product (or different products) are undertaken at the different stops along the route, Although not at all necessary, the inventors have found that use of a bus stop metaphor is particularly useful in allowing others to appreciate the many benefits of the contemplated systems, apparatus and methods.

Electronics to perform that processing contemplated herein can be located local or distal to the resource(s) being scheduled and/or re-scheduled.

One should appreciate that the disclosed techniques provide many advantageous technical effects including modification of a previously optimized Kanban schedule to accommodate changes in demand data for a product being produced according the schedule.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a computer system according to the inventive subject matter.

FIGS. 2A is a schematic of a sequence in a cycle that can be used in scheduling a resource to produce N products.

FIGS. 2B, 2C, 2D, 2E and 2F are all schematics of the same cycle as FIG. 2A, but modified to skip one or more steps of substeps.

FIG. 3 is a schematic of an interface for software that utilizes a bus stop metaphor to assist in scheduling a resource.

### DETAILED DESCRIPTION

The following discussion provides several example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

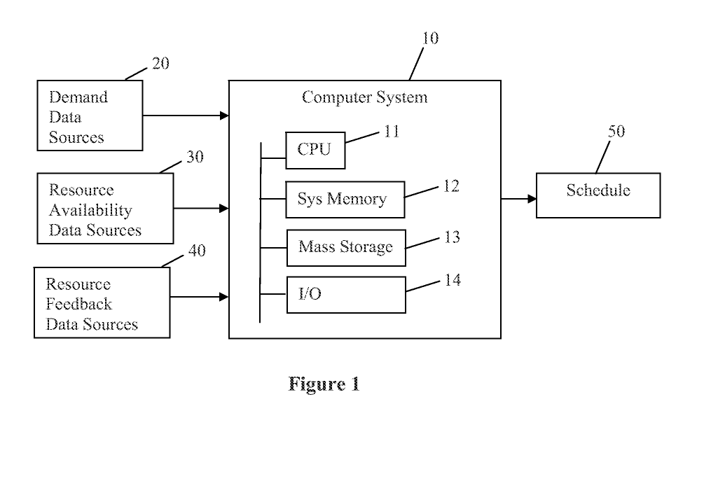

In FIG. 1 an exemplary computer system 10 has inputs of demand data source(s) 20, resource availability data source(s) 30, and resource feedback data source(s) 40. Each of the data sources 20, 30, and 40 comprise one or more physical electronics, which can be other computer systems, cell phones, tablets, PDAs, keyboards and mice, and so forth. It is especially contemplated that one or more cell phone or other devices with a wireless communication capability can be used to operate as one or more of the data sources, 20, 30, 40, so that, for example, a person can provide data to the computer system 10 as he/she walks around a production facility, sales floor, or other environment. Computer system 10 outputs a schedule 50, which can be provided as a paper printout, a visual display, an electronic file, or in any other format.

Computer system 10 can be any suitable general or special purpose computing device having a processing unit 11, a system memory 12, a mass storage memory 13, an input/output unit 14, and a system bus 15 that couples various system components including the system memory 12 to the processing unit 11. The processing unit 11 can perform arithmetic, logic and/or control operations under control of software running on an operating system, The system memory 12 can have any suitable physical characteristics, and can be any combination of volatile and non-volatile memory. Data records storing information relating to demand data, resource availability and feedback are preferably stored on the mass storage memory 13, and more preferably in a database structure.

Although in many practical embodiments, computer system 10 will be local to the factory, hospital or other facility from which products are being produced. It is contemplated, however, that one or more of the functionalities of the various components of computer system 10 can be virtualized distally, in a cloud computing environment or otherwise.

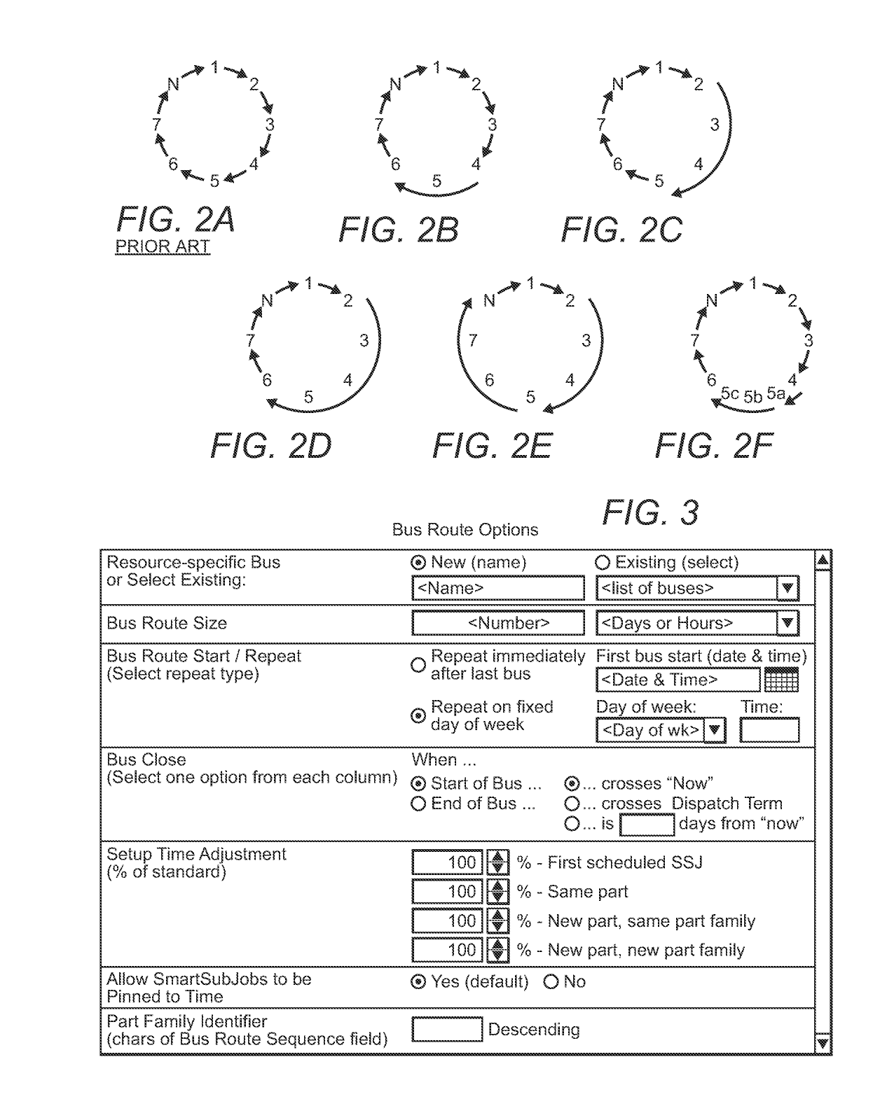

FIG. 2A diagrams a sequence of N steps used to produce N different products, respectively, with the arrows designating a Kanban type default sequence previously considered to be a most efficient, or at least a particularly efficient sequence according to a measure of efficiency.

As used herein, the term “product” should be interpreted broadly herein to include anything that the production of which can be scheduled. This includes include both tangible and intangible products, and also services. Thus, the product of a patent attorney could be a patent application or a patent ft ling, the product of a physician could be a medical examination, and the product of a quality assurance examiner could be a certification or an approval report. A product could also be virtual, such that the product of an office worker could be storage of information, which might be perceivable only in the form of a report, a spreadsheet, a drawing, etc.

As used herein in the context of a service type of product, “production” of the product should be interpreted herein to mean performing or otherwise provisioning of the service, For example, if an office worker's product is spell-checking a document, production of that service could mean the act of spelt-checking the document, or perhaps obtaining the services of another to spell-check the document.

As used herein the term “provisioning” means making available, including manufacturing, making, obtaining, securing, and otherwise providing.

As used herein with respect to products, the term “part” can refer to a tangible component of a tangible product, or an intangible component of software or other intangible product, and analogously, portions of a service being provided. In some instances a product can comprise a single part, which is then sold or otherwise provided to a marketplace. In such instances the terms “part” and “product” would be co-extensive. In other instances a product could comprise multiple parts. In yet other instances, a part could be a product in itself, and also one of multiple parts in a product. For example, a computer manufacturing company might manufacture electronic boards, and sell them as standalone products. The same company might also include those boards in a computer, and then sell the computer as a product.

Products can be viewed as members of one or more families. Thus, different sizes of screws could be considered members of a family of screws, with different sub-families based on thread pattern or head shape. Service products are also contemplated to exist in families. For example, where a product is a medical procedure or running of a diagnostic test, a family could include similar types of procedures or tests.

In general, the concept of product families as used in the context of scheduling, refers to parts or products that have similar resource requirements. Thus, referring back to the example of a family of screws, production of each of the different types of screws in a family would tend to use the same type of raw material, the same milting equipment, similar tooling within the equipment, and so forth.

Contemplated cycles can have any realistic number of steps, and substeps. A cycle having only one or two steps and no substeps, however, is of no consequence, and is expressly excluded from the terms “cycle” or “cycles as those terms are used herein. Thus, in FIG. 2, steps 4-N are optional. At the other extreme, a cycle having hundreds of steps or substeps might be so complex that systems and methods contemplated herein would be of minimal value. The sweet spot is probably working with cycles that have a total of five to fifty steps and substeps.

Different steps in a cycle can be associated with production of the same or different products. For example, in a manufacturing context, different steps could be associated with producing different sizes, configurations, components and wirings of the same or analogous parts. In the particular example of construction of a desktop computer, different steps could involve inserting a disk drive, an internal memory card, an interface card, and so forth.

In FIG. 2B, the sequence of N steps used to produce N products has been altered in accordance with demand data so that step 5 is skipped, thus precluding production of product 5.

Demand data used to skip step 5 in FIG. 2B, or other steps in other Figures, can be acquired from any suitable sources, including especially electronic or printed orders. Of particular interest is demand data that reflects quantities and delivery or production dates, and flexibility in production (which should be construed as performance in the case of a service).

Demand data used to skip step 5 in FIG. 2B, or other steps in other Figures, is preferably data reflecting expected medium term demand, which is defined herein to cover a time period of between 3 and 14 days, more preferably between 5 and 9 days, and most preferably 7 days.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

In FIG. 2C, the sequence of N steps used to produce N products has been altered in accordance with demand data so that steps 3 and 4 are both skipped, thus precluding production of products 3 and 4.

In FIG. 2D, the sequence of N steps used to produce N products has been altered in accordance with demand data so that steps 3, 4, and 5 are all skipped, thus precluding production of products 3, 4 and 5,

In FIG. 2E, the sequence of N steps used to produce N products has been altered in accordance with demand data so that steps 3, 4, 6 and 7 are all skipped, thus precluding production of products 3, 4, 6 and 7.

FIG. 2F shows the same sequence of N steps used to produce N products as in FIGS. 2A, 2B, 2C, 2D and 2E. Here, however, step 5 (used to produce product 5) is expanded to show substeps 5a, 5b and 5c. In this particular instance, and production has been has been altered by skipping substeps 5b and 5c, in accordance with demand data.

It is also contemplated that the demand data might present a situation where a default schedule is modified in a manner that is less efficient according to the measure of efficiency. For example, if the demand data includes information that demand for the first item is flexible while demand for the second item is inflexible, it might be advantageous for the system to skip over at least one of the steps or substeps involved in producing the first item, even though there are high costs and lowered efficiency in doing so. This might well happen in the case of a hospital, where surgeries are scheduled in a surgical suite according to an efficient cycle of staff availability and prep/cleanup times. If the hospital is suddenly confronted with the need to perform an emergency surgical procedure, the demand is so high and so inflexible that it makes sense to skip over one or more previously established steps.

In another example, the demand data may show that a first product is needed at an unusually high volume. In that case a default schedule might be modified in a manner that bypasses production of that product on the usual machine, so that the product can be produced on a different machine that can handle higher volumes.

Systems and methods contemplated herein can interface with a user in any suitable manner. In many instances, however, the interface will be computer generated, and will render information to the user on paper or using some sort of visual display, Displaying information in the form of metaphors can be helpful in that regard, and one class of metaphors that is thought to be especially valuable are metaphors that treat steps of a cycle as being carried by a transport. Transport metaphors that are currently thought to be useful include one or more of a bus, train or a ship carrying a set of orders or other requirements around a route with stops along the way corresponding to the steps of a cycle. FIG. 3 is an example of such an interface suing a bus stop metaphor to assist in scheduling a resource.

Although various parameters are presented to users within the context of a metaphor, the computer software and hardware providing the metaphor would very likely store the related information as records in an electronic file using some form of database records.

### Example 1

A manufacturing company produces precision optics, where fabricated parts are machined for assembly. These machined parts are stored in a “supermarket” between machining and assembly using a Kanban type system to signal a requirement back to machining as assembly consumes them. These parts have a consistent demand with the some parts being consumed daily in assembly, The three issues of greatest concern are: daily material shortages, excess inventory and machining capacity. The solution is to establish a bus route methodology and to “right size” the Kanban quantities,

The assets that are the most capacity-constrained are the Swiss Turning Centers, so that is where the bus route methodology was deployed. First, families of similar parts were defined regardless of what specific asset was producing them using the router as the initial set of data. The similarities indicated what tools were being employed and this was validated in the second pass at families. The programs were then evaluated and revised to ensure the same locations were used for the same tools. At this point a capacity check was performed to validate the family definition was within the desired load for an asset.

A sequence was then defined for every part within the families for each asset that minimized the changeover time from part to part. This sequence only took into account tooling and changeover similarities. Demand variation had no impact on the family definition, or placement in the sequence.

A demand accumulation period was then defined as a week. Because the parts were fairly consistent in demand, it was determined that a week would be long enough to accumulate enough demand across each family to take enough advantage of the changeover optimization.

In execution, demand accumulates for a week, the parts that need to be produced are then placed in the appropriate sequence and a schedule is provided to machining for the following week by turning asset. The critical step, with respect to the currently claimed subject matter, is that any parts that were in the sequence, but did not have any demand for the week were skipped.

The results were an increase in capacity by about 20% as changeover times were reduced and a decrease in inventory by about $3 M for the machined parts. As the company had about 37 Swiss Turning Centers, about $250 to $300 K each, the cost avoidance was about 7 Turning Centers or about $2 M in saved capital expenditure.

### Example 2

MTO (make to order) fabrication company supplies various agricultural, automotive and other markets. This company does both repetitive parts, as well as “one off” parts. They typically cut sheet metal via laser or punch, brake (bend), stamp, deburr, and sometimes punch or machine. The two issues of greatest concern are: machine capacity and response time.

The assets that were perceived as the most capacity constrained were the brakes. So that is where the bus route methodology was implemented. Where other machining have many “pockets” for tools, or a tool holder attached to a machine, brakes are limited by the width of the bed and the depth of each individual tool. So, changeovers can be lengthy and may be required when performing multiple bends on the same part on the same machine.

Families of similar parts were established using the prints that indicated similar tooling requirements and size of part. The tools were then evaluated to determine which asset could be used. Then material thickness was reviewed as the amount of force required to bend the part increases with material thickness and the available assets had varying tonnage capacity. A capacity check was then performed to ensure the desired load was reflected in the part families selected by asset.

A sequence was then developed by first identifying the parts that used the same bottom half of the tool and then the appropriate sequence for the replacement of the top half This defined the first family. This progression was repeated until all the families were defined for that asset.

A demand accumulation period was then defined as a week. It was determined that a week would be long enough to accumulate enough demand across each family to take enough advantage of the changeover optimization as a starting point. The accumulation period was to be reviewed over time by asset and changed as appropriate.

A brake was paired with either a laser, or a punch and the output of those assets went immediately to the brake when each sheet was cut.

In execution, demand accumulates for a week, the parts that need to be produced are then placed in the appropriate sequence and a schedule is provided to the laser or punch for the following week by the brake sequence. Here again, the critical step with respect to the currently claimed subject matter, is that any parts that were in the sequence, but did not have any demand for the week were skipped.

It was estimated that the bus route would provide an increase in brake production capacity by about 15 to 17%.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A system for scheduling a resource, comprising electronics having at least one processor configured to:
access a cycled schedule that includes an ordered sequence of first, second and third steps performed on the resource, wherein a dependence exists with respect to performance of the first, second and third steps, and wherein the schedule corresponds to an efficient provisioning of first, second and third items, respectively;
receive demand data for at least one of the first, second and third items; and,
utilize the demand data to schedule utilization of the resource in a manner that skips over at least one of the steps in a manner that improves a measure of efficiency.

2. The system of claim 1, wherein the first, second and third steps have first, second and third substeps, respectively, and the measure of efficiency includes reducing a cost associated with bypassing at least one of the substeps.

3. The system of claim 2, wherein the cost comprises at least one of a setup cost and a cleanup cost.

4. The system of claim 2, wherein the cost comprises an activity time.

5. The system of claim 2, wherein the cost comprises at least one of a cost selected from the group consisting of an energy cost, a disposal cost, a loss of business cost, a penalty cost, and a reputation cost.

6. The system of claim 1, wherein the resource comprises a machine, and the measure of efficiency includes reducing a cost associated with bypassing a substep of re-tooling the machine.

7. The system of claim 1, wherein the dependence is a function of a setup time of the first step immediately preceding the third step relative to setup time of the second step immediately preceding the third step.

8. The system of claim 1, wherein the resource comprises a person, and the measure of efficiency includes reducing a cost associated with getting the person to a desired location.

9. The system of claim 1, wherein the resource comprises a consumable that is consumed in production of the product, and the measure of efficiency includes reducing a cost associated with getting the consumable to a desired location.

10. The system of claim 1, wherein the resource comprises a physical location, and the measure of efficiency includes reducing a cost associated with a lag time in prepping the location.

11. The system of claim 10, wherein prepping the location comprises configuring a piece of equipment at the location.

12. The system of claim 1, wherein the first, second and third items comprise different physical products, respectively.

13. The system of claim 1, wherein the first, second and third items comprise different configurations of a physical product.

14. The system of claim 1, wherein each of the first, second and third items comprise services.

15. The system of claim 14, wherein at least one of the services comprises a medical procedure.

16. The system of claim 14, wherein at least one of the services comprises a testing procedure.

17. The system of claim 14, wherein at least one of the services comprises a quality assurance procedure.

18. The system of claim 14, wherein at least one of the services comprises a data processing procedure.

19. The system of claim 1, wherein each of the first, second and third items comprise electronically stored information.

20. The system of claim 1, wherein the electronics is further configured to interact with a user in a manner that conceptually treats the steps as being carried by a transport.

21. The system of claim 1, wherein the utilization of the cycled schedule with respect to first, second and third items comprises a Kanban type of scheduling, and the electronics is further configured to treat the steps as records in an electronic file.

22. The system of claim 1, wherein the reputing ordered sequence includes a fourth step that corresponds with provisioning a fourth item.

23. The system of claim 22, wherein the electronics is further configured to schedule utilization of the resource in a manner that skips over at least two the steps in a manner that improves the measure of efficiency.

24. The system of claim 1, wherein the first and second items are members of a family of products, the demand data includes information that the first item is needed at a volume no more than 1/10th that of the second item, and skipping over the at least one of the steps improves the measure of efficiency by skipping a previously established run of the first item.

25. The system of claim 1, wherein the electronics is local to the resource when the resource is being used to facilitate re-scheduling utilization of the resource.

26. The system of claim 1, wherein the electronics is distal to the resource when the resource is being used to facilitate re-scheduling utilization of the resource.

27. The system of claim 1, wherein each of the first, second and third steps is directed toward manufacturing a different product.
